(19) United States
(12) Patent Application Publication
(10) Pub. No.: US 2024/0009871 A1
(43) Pub. Date: Jan. 11, 2024

(54) Knife Set With Replacement Blades

(71) Applicant: Stanley Payne, Brookshire, TX (US)

(72) Inventor: Stanley Payne, Brookshire, TX (US)

(21) Appl. No.: 17/859,511

(22) Filed: Jul. 7, 2022

(51) Int. Cl. B26B 5/00; B25G 1/08; B25G 1/10

(52) U.S. Cl. CPC B26B 5/00; B25G 1/08; B25G 1/102

(57) ABSTRACT

The chef razor knife/knives is the only product of its kind that offers users a primary knife option possessing interchangeable, replaceable blades to eliminate the need of constantly resharpening a single knife blade. This unprecedented product is uniquely designed with a wide variety of blades including but not limited to: an eight inch blade, a ten inch blade, a bread knife blade, a slicing blade, a utility blade and a boning blade. Furthermore, this unprecedented product is carefully crafted with durable, high-quality materials to ensure long-term sustainability and safe user management.

### BACKGROUND

While one certainly needs to take care when using sharp knives, a dull blade is often more dangerous than a sharp blade as it limits effectiveness and requires using extra hand strength to compensate for its lack of sharpness. To combat this, one can constantly sharpen a knife, however, the act of doing so can be a tedious, time-consuming and inconvenient process. There have been no products available as original equipment or as an aftermarket to address this problem.

An apparatus that allows you the ability to always have a sharp blade on your knife is not being met by any known device or system at present. There have been no products available as original equipment or as an aftermarket to address this problem either.

### SUMMARY OF THE INVENTION

The main purpose of knife set with replacement blades is to provide users with a knife with different interchangeable blades to guarantee a knife is never dull.

A disclosed knife includes a knife blade comprising a hook defined by a void complementary to the hook in a knife spine thereof and comprising a tang portion configured to define a plurality of securing holes therein. The disclosure also includes a knife handle configured to extend over a portion of the knife blade and comprising two sides joined by at least one securing pin and configured to define an open spine interleaved with the two sides in a back thereof. The disclosure further includes a swing pin disposed in the knife handle extended portion and encircled by the knife blade hook to enable the knife blade to swing into the open spine in an interleaved relation to the knife handle based on a closure of the swing.

### BRIEF DESCRIPTION OF THE DRAWINGS

FIG. 1 is a left side elevational view of the knife with an assembled replacement blades in accordance with an embodiment of the present disclosure.

FIG. 2 is a top view of the knife with a replacement blade in accordance with an embodiment of the present disclosure.

FIG. 3 is a left side elevational view of the knife with a top down replacement blade in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

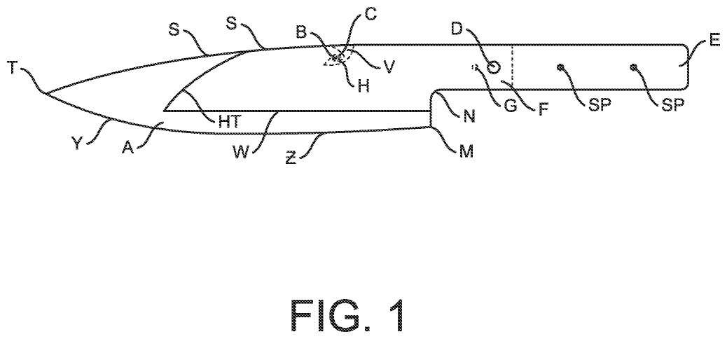

FIG. 1 is a left side elevational view of the knife with an assembled placement blade showing: knife blade referenced as A, swing pin to secure hook referenced as B, blade's hook referenced as C, removable twistable blade lock mechanism referenced as D, handle with snug grip referenced as E, knife skeleton referenced as F where the blade A swings into a locking position respective to the knife skeleton F. The spring loaded pin will go through hole in knife handle referenced as G, knife securing pins referenced as SP, knife heel N, knife bolster M, knife blade edge Z, knife handle extended portion edge W, knife blade belly Y and knife tip T, knife blade spine S and knife blade hook H and void V in accordance with an embodiment of the present disclosure. The knife handle tip HT supports the knife blade tip.

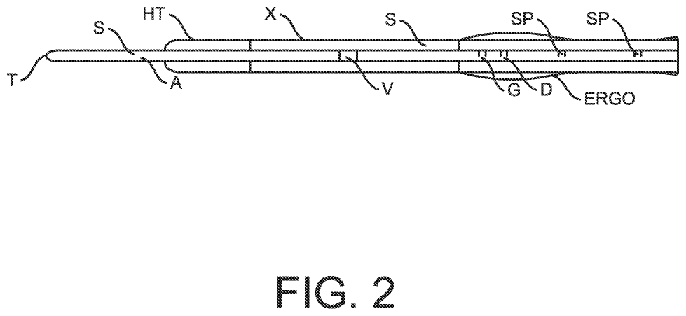

FIG. 2 is a top view of the knife with a replacement blade showing the back of the knife handle X, the void V opening on the knife blade spine S, the tip T, the blade A, the spring loaded pin G, the twistable blade lock D and the ergonomic grips ERGO and the securing pins SP shown in broken lines extending from the sides of the handle through the knife blade tang and the knife handle tip HT.

The present disclosed knife set with replacement blades, also known as the “Chef Razor Knife/Knives” offers a modem accessory that ensures users have access to a sharp knife at all times thus reducing the likelihood of injury, eliminating the need of sharpening the tool, and allowing for safer and immediate cutting capabilities. Expanding on the initial design of an average knife, the chef razor knife/knives introduces a novel knife with a replaceable blade that provides users with a brand new razor sharp knife whenever it's needed. The blade hooks and secures into the spine of the knife's skeleton and a locking mechanism in the handle secures the blade into position once established. To further enhance functionality, the chef razor knife/knives comes with a wide variety of blades that serve different purposes, making the set a versatile medium for meeting domestic and/or hunting/outdoor necessities. This innovative, top-quality product ensures a fully operational knife that will benefit all individuals including but not limited to: home cooks, restaurant and hotel chefs, butcher shops, or virtually any individual in need of a sharp and versatile knife.

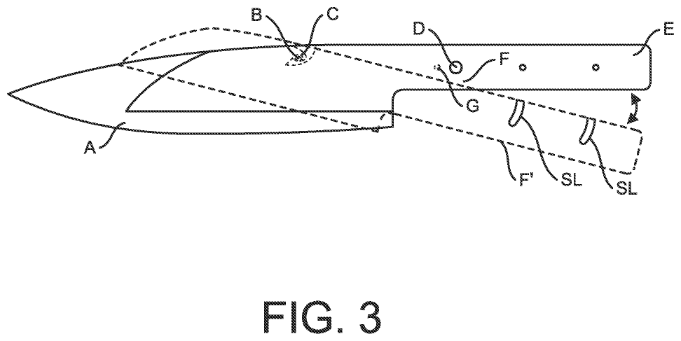

FIG. 3 is a left side elevational view of the knife with a top down replacement blade in accordance with an embodiment of the present disclosure. The reference lines and reference characters of FIG. 2 are same except for the knife blade slots SL which are curved for a bottom up folding action of the knife skeleton F depicted in swing position as F′ and in swing position as F′ where the blade A swings down into a locking position respective to the knife skeleton F.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A knife comprising:
a knife blade comprising a hook defined by a void complementary to the hook in a knife spine thereof and comprising a tang portion configured to define a plurality of securing holes therein;
a knife handle configured to extend over a portion of the knife blade and comprising two sides joined by at least one securing pin and configured to define an open spine interleaved with the two sides in a back thereof;
a swing pin disposed in the knife handle extended portion and encircled by the knife blade hook to enable the knife blade to swing into the open spine in an interleaved relation to the knife handle based on a closure of the swing.

2. The knife of claim 1, wherein the knife blade tang further defines a curved slot configured to receive the at least one securing pin in the swing.

3. The knife of claim 1, wherein the knife blade tang further defines two curved slots configured to receive the at least one securing pin in the swing.

4. The knife of claim 1, wherein the extended portion of the knife handle extends proximal a belly of the knife blade.

5. The knife of claim 1, further comprising a removable twist blade lock having helical threads complementary to helical threads on an inside of one of the securing holes in the handle.

6. The knife of claim 1, further comprising a spring loaded pin in the handle and configured to go through one of the plurality of securing holes in the handle.

7. The knife of claim 1, further comprising a curvaceous handle portion configured to receive a human hand.

8. The knife of claim 1, wherein the knife blade void is accessible via the blade spine proximal the swing pin after the closure of the swing.

9. The knife of claim 1, wherein the knife handle extends proximal an edge of the knife blade.

10. The knife of claim 1, wherein a tip of the hook faces towards the knife blade edge.

11. The knife of claim 1, wherein a tip of the hook faces towards the knife blade tip.

12. The knife of claim 1, wherein the void is configured to guide the swing pin into a locking position with the hook.

13. The knife of claim 1, wherein the knife handle further comprises a bolster.

14. The knife of claim 1, wherein the knife handle further comprises a heel.

15. The knife of claim 1, wherein the knife handle further comprises an edge proximal the knife blade edge from a bolster thereof proximal a tip thereof.

16. The knife of claim 1, wherein the knife blade is a replacement blade.

17. The knife of claim 1, wherein the knife is part of a set of knives each having its own knife blade with hook, void and tang, knife handle with securing pin, open spine and interleaved sides and swing pin in the knife handle extension.

18. The knife of claim 1, further comprising a knife handle tip extending proximal the knife blade tip in a sloping geometry forming a matching tip.
